(19) United States
(12) Patent Application Publication
(10) Pub. No.: US 2026/0070478 A1
(43) Pub. Date: Mar. 12, 2026

(54) COLLAPSIBLE AND REMOVABLE HORSE TACK COMPARTMENT FOR A TRAILER

(71) Applicant: Brad Heath, Wilmington, NC (US)

(72) Inventor: Brad Heath, Wilmington, NC (US)

(21) Appl. No.: 19/352,404

(22) Filed: Oct. 7, 2025

Related U.S. Application Data
(60) Provisional application No. 63/680,539, filed on Aug. 7, 2024.

(51) Int. Cl. B60P 3/04; B60P 7/135

(52) U.S. Cl. CPC B60P 3/04; B60P 7/135

(57) ABSTRACT

A collapsible and removable tack storage compartment for horse trailers is disclosed. The compartment includes a housing defined by panels and a front door, hinge assemblies that permit folding between extended and collapsed configurations, latch assemblies that secure the door, and mounting brackets that attach to a trailer door or wall while enabling removal. In certain embodiments the housing is trapezoidal or rectangular and may include saddle racks, bridle hooks, and shelving. Modular construction allows shipment as a kit and end-user assembly. Quick-release mounting and optional reinforcement members provide durability for transport while allowing tool-free removal to increase trailer clearance. The design improves safety and usability by providing full-sized storage when deployed, compactness when collapsed, and compatibility with various trailer geometries.

### CROSS-REFERENCE TO RELATED APPLICATIONS

This application claims the benefit of U.S. Provisional Patent Application No. 63/680,539 filed on Aug. 7, 2024, entitled “COLLAPSIBLE AND REMOVABLE HORSE TACK COMPARTMENT FOR A TRAILER,” the disclosure of which is hereby incorporated by reference in its entirety.

### FIELD

The present disclosure relates generally to storage compartments for horse trailers, and more particularly to a collapsible and removable horse tack compartment that can be affixed to the rear door of a trailer.

### BACKGROUND

Horse trailers are commonly equipped with tack storage areas for saddles, bridles, grooming tools, and other equipment. Traditionally, these tack compartments are fixed in place, welded or bolted directly to the trailer door or wall. While functional, such fixed compartments present several disadvantages. They reduce trailer entry clearance. They create hazards for handlers. They increase weight. They complicate repairs.

Conventional rear tack compartments in horse trailers are typically attached to the sidewall of the trailer. These compartments obstruct the path when loading or unloading horses. The obstruction requires the removal of all equipment before horses can be safely loaded or unloaded. The compartment walls must be folded before loading operations can commence. This process is impractical. This process creates safety hazards for both the horse and handler.

Some existing solutions include compartments that are permanently fixed to trailer doors. These compartments swing out with the door during opening. This provides unobstructed access for loading and unloading horses. However, these compartments cannot be removed when additional hauling space is required. The compartments cannot be collapsed when additional hauling space is required. This limits the versatility of the trailer. The limitation is particularly problematic when owners wish to transport items other than horses, such as furniture or recreational vehicles.

There is a need for improved solutions.

### BRIEF OVERVIEW

The following presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various embodiments described herein relate to a collapsible and removable horse tack compartment that can be affixed to the rear door of a trailer. The compartment may be designed to be manufactured in sections using various manufacturing techniques, allowing for easy shipping and installation by end users on their existing trailers. When the compartment is attached to the rear door, it may swing out with the door during opening, providing unobstructed access for loading and unloading horses without first having to empty the compartment of gear.

In some embodiments, the compartment may include a folding mechanism that allows it to collapse for space efficiency when not in use and expand when storage is needed. The compartment may be designed to be mounted to trailer doors via mounting systems such as rubber wells, making it both securely attached during use and removable when desired.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is an isometric view of the tack storage compartment in the closed and locked position in accordance with some embodiments.

FIG. 2 is a rear perspective view of the tack storage compartment in the open position, showing internal storage features in accordance with some embodiments.

FIG. 3 is a side view of the tack storage compartment in a collapsed configuration in accordance with some embodiments.

FIG. 4A, 4B, 4C show an exploded view showing modular panels, frame members, hinge assemblies, and latch mechanisms in accordance with some embodiments.

FIG. 5A, 5B, 5C show a sequential diagram showing the transition from collapsed to fully extended states in accordance with some embodiments.

FIG. 6A, 6B show a close-up detail view of a hinge assembly connecting adjacent panels in accordance with some embodiments.

FIG. 7 is a close-up detail view of a latch and locking pin assembly in accordance with some embodiments.

FIG. 8 is a perspective view of the tack storage compartment mounted on a trailer door, open position in accordance with some embodiments.

FIG. 9 is a perspective view of the tack storage compartment mounted within the trailer in a closed position in accordance with some embodiments.

FIG. 10 is a perspective view of an alternative rectangular embodiment of the tack storage compartment in accordance with some embodiments.

### DETAILED DESCRIPTION

The present disclosure describes various embodiments of a collapsible and removable horse tack compartment for a trailer. In the following description, for purposes of explanation, numerous specific details are set forth in order to provide a thorough understanding of the various aspects of the disclosed subject matter. It may be evident, however, that the disclosed subject matter may be practiced without these specific details. In other instances, well-known structures and devices are shown in block diagram form in order to facilitate describing the subject matter.

It should be understood that the examples and embodiments described herein are for illustrative purposes only and that various modifications or changes in light thereof may be suggested to persons skilled in the art and are to be included within the spirit and purview of this disclosure and the accompanying claims. Additionally, the claimed subject matter is not limited to embodiments that solve any disadvantages or that operate only in environments such as those described above. Rather, the embodiments, features, components, and methods described herein may be used independently and separately from other components and methods described herein.

Furthermore, to the extent that the term “includes” is used in either the detailed description or the claims, such term is intended to be inclusive in a manner similar to the term “comprising” as “comprising” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

The implementations described below are discussed in the context of a collapsible and removable horse tack compartment for a trailer. However, the techniques described herein may be used in other contexts as well. For instance, the techniques may be applied to other types of storage compartments for various vehicles or structures.

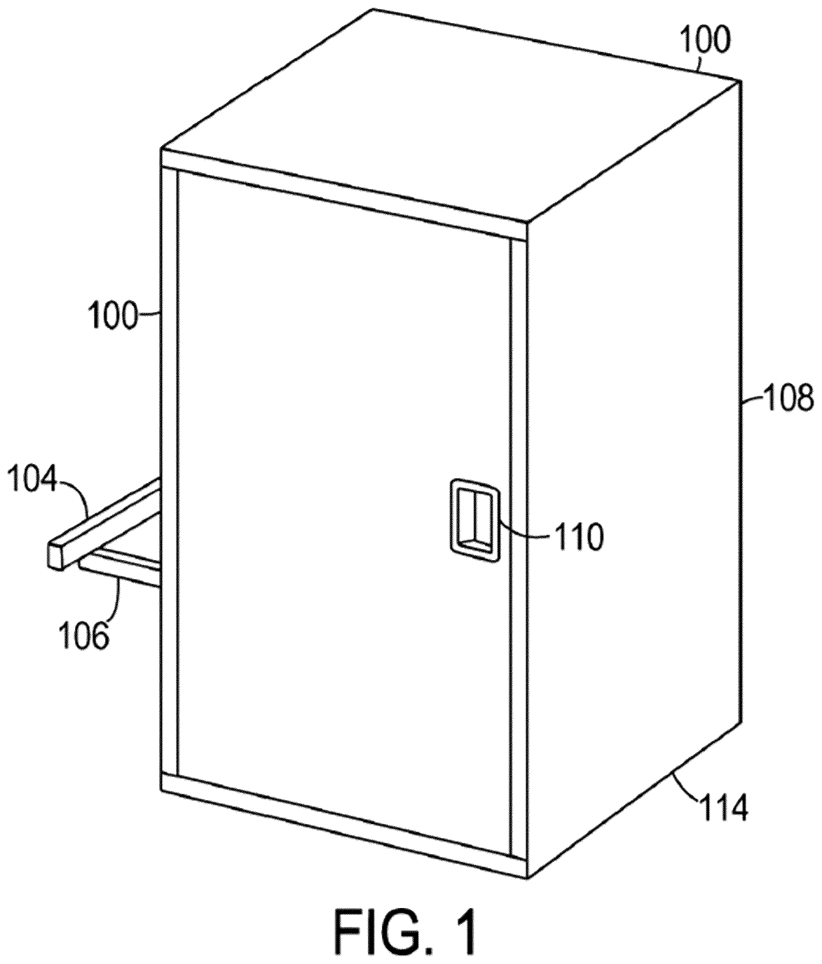

Referring now to FIG. 1, a perspective view of a collapsible and removable horse tack compartment 100 may be illustrated in accordance with some embodiments. The compartment 100 may be designed to be affixed to the rear door of a horse trailer. The compartment 100 may include an enclosure body 110 constructed of suitable materials such as aluminum sheets and tubing. In some embodiments, the aluminum sheets may have a thickness of approximately 0.063 inches, although other thicknesses may be used depending on strength requirements and weight considerations.

In one or more embodiments, the compartment 100 may be designed with specific dimensions to accommodate standard horse tack items, such as saddles, bridles, and other equipment. The compartment 100 may include structural elements such as aluminum tubing, which may include 1″×2″×23.88″ tubing elements at the top portion of the compartment. The enclosure body 110 may be formed by a top panel 112, bottom panel 114, opposing side panels 116, 118, rear wall 119, and front door 120. Hinges 122 and latch assemblies 124 may secure the door 120 in its closed position.

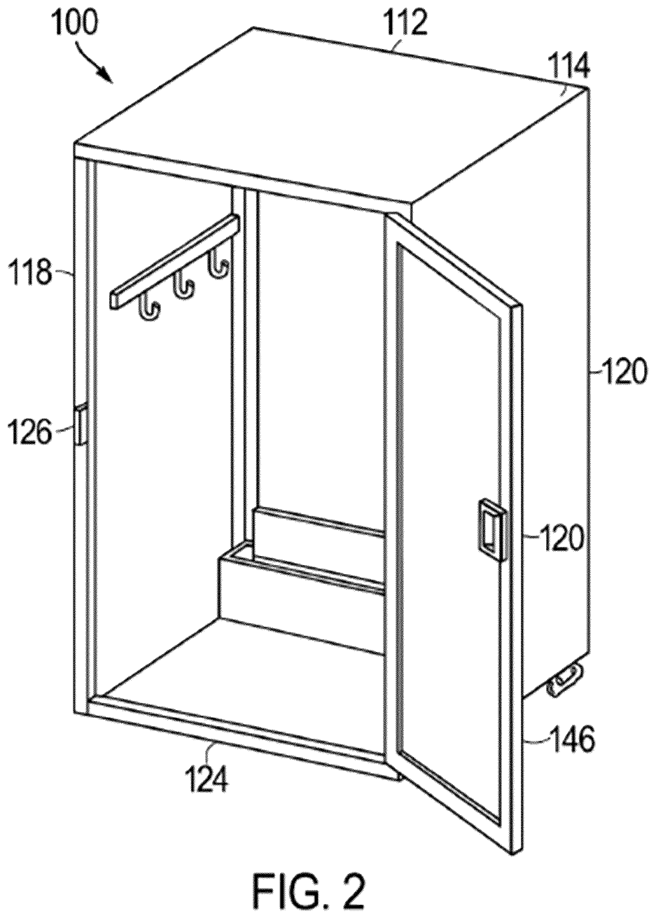

FIG. 2 may illustrate the compartment open, exposing saddle racks 130, bridle hooks 132, and optional shelves 134. The racks 130 may be adjustable or removable to accommodate various equipment. This view may show additional features of the compartment, such as access panels, latching mechanisms, or interior organization elements. The compartment 200 may be designed to provide secure storage for valuable tack equipment while being easily accessible when needed.

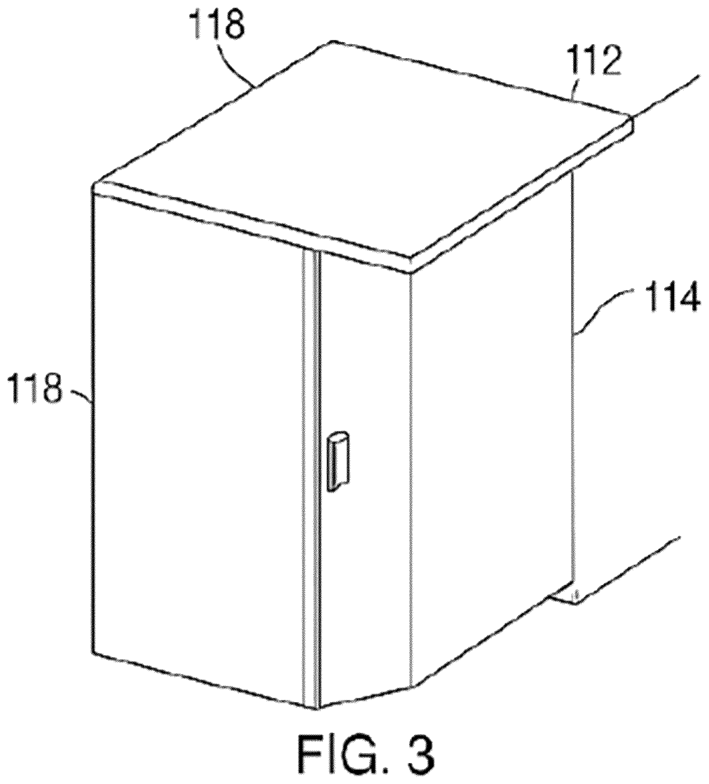

FIG. 3 may depict the compartment collapsed, wherein hinge assemblies 140 allow panels to fold flat for compact storage or shipping. The compartment 300 may include a folding mechanism that allows it to collapse for space efficiency when not in use and expand when storage is needed. This folding mechanism may include multiple hinged connections that allow the compartment to fold flat against the trailer door.

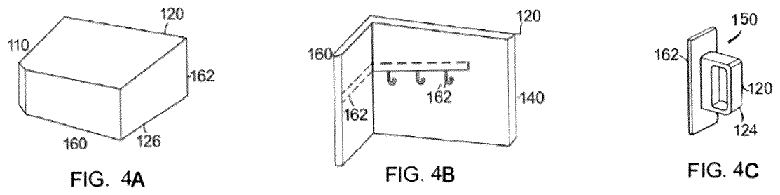

FIG. 4A, 4B, 4C may show an exploded view highlighting the modular design: panels interconnect via fasteners 142, hinges 140, and mounting brackets 146. This modularity may allow shipping in kit form, enabling end-user assembly. The sequential unfolding of the compartment may be seen in this figure, showing how the panels may be arranged to create the storage space when deployed.

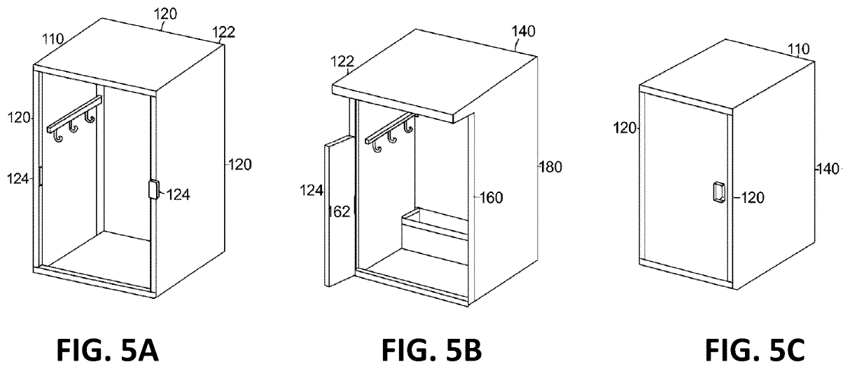

FIG. 5A, 5B may demonstrate sequential operation: collapsed, partially extended, and fully extended configurations. The compartment 500 may include multiple foldable panels arranged to create the storage space when deployed. These panels may collapse in a specific sequence to achieve a compact folded state when not in use.

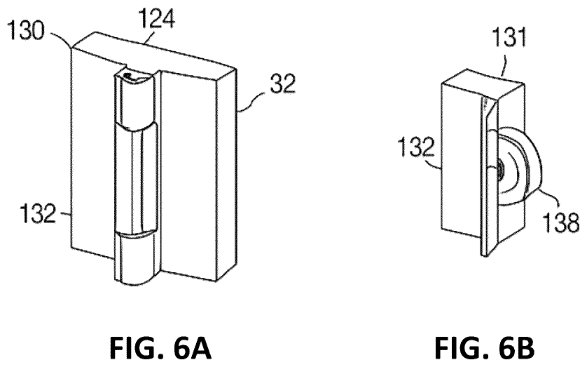

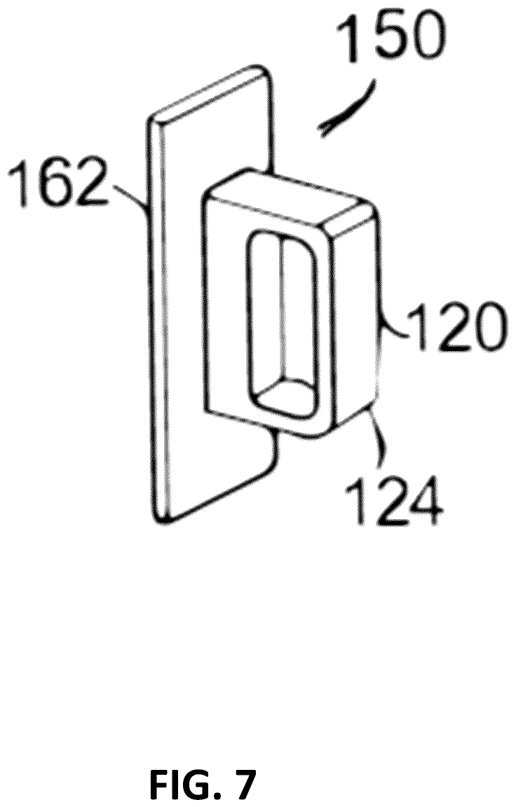

FIGS. 6A, 6B and 7 may show detail views of the hinge 140 and latch 124, 126. Hinges may be continuous piano hinges, segmented hinges, or interlocking modular designs. Latches may be rotary, cam-style, or spring-loaded, with optional quick-release designs. The compartment 600 may be designed to unfold to the left side, providing easy access to contents when fully deployed. The unfolding operation may be designed to be performed by a single person without requiring special tools or excessive force.

In one or more embodiments, the compartment 700 may include locking mechanisms to secure it in both deployed and collapsed positions. These mechanisms may include quick-release features for rapid conversion between states and safety features to prevent accidental collapse when in use.

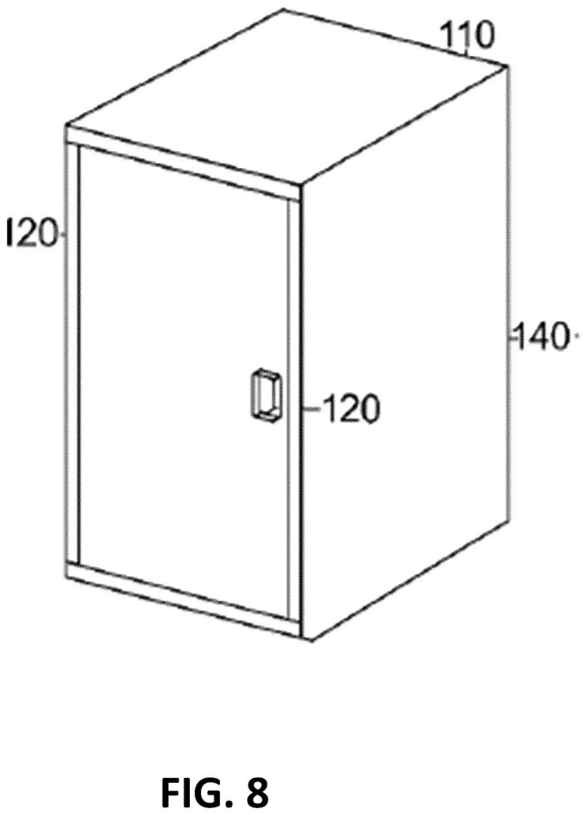

FIG. 8 may depict the compartment mounted to a trailer rear door 150, swinging outward when the door opens. Mounting brackets 146 may allow quick release and secure engagement. When fully deployed, the compartment 800 may provide ample storage space for horse tack and equipment. The compartment 800 may include interior features such as dividers, hooks, or specialized compartments for different types of equipment.

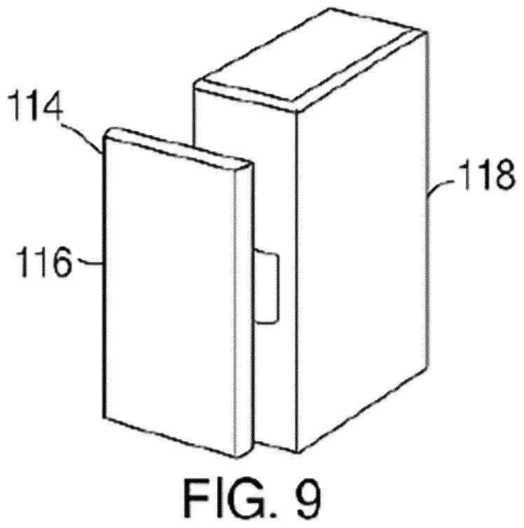

FIG. 9 may show the compartment in closed transport configuration. The compartment 900 may be designed to be mounted to trailer doors via mounting systems such as rubber wells. These rubber wells may be permanently affixed to the trailer door and designed to receive mounting points from the compartment. The mounting system may provide vibration dampening during transit and allow for secure attachment without permanent modification to the compartment. The corresponding attachment points on the compartment may be designed for quick installation and removal, configured to maintain secure attachment during trailer movement, and may include alignment features for proper positioning.

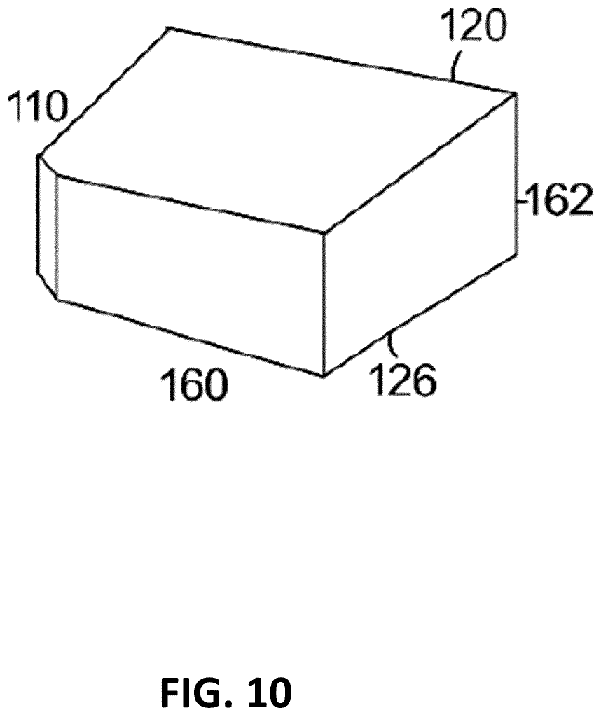

FIG. 10 may illustrate a rectangular embodiment suitable for alternate trailer geometries. When attached to the rear door of the trailer, the compartment 1000 may swing out with the door during opening, providing unobstructed access for loading and unloading horses without first having to empty the compartment of gear.

In one or more embodiments, the enclosure body 110 may comprise multiple interconnected panels that form the overall structure of the tack storage compartment 100. The top panel 112 may provide the upper boundary of the storage space and may be constructed from lightweight aluminum sheets or composite materials. The top panel 112 may include reinforcement elements to support the weight of stored tack items and maintain structural integrity during transport. The bottom panel 114 may form the base of the compartment and may include drainage features or non-slip surfaces to secure stored equipment.

In one or more embodiments, the first side panel 116 and second side panel 118 may define the lateral boundaries of the storage compartment and may be configured to fold relative to adjacent panels during collapse operations. These side panels may include mounting points for interior storage elements such as saddle racks 130 or bridle hooks 132. The rear wall 119 may provide structural stability to the overall assembly and may serve as a mounting surface for various storage accessories. The rear wall 119 may be permanently fixed or may be removable to facilitate access or maintenance.

In one or more embodiments, the front door 120 may provide access to the interior storage space and may be secured via the latch assembly 124. The door 120 may include weatherproof sealing elements to protect stored tack from environmental conditions during transport. The door hinge 122 may enable the door 120 to swing open while maintaining secure attachment to the enclosure body 110. The hinge 122 may be a continuous piano hinge or may comprise multiple discrete hinge elements distributed along the door edge.

In one or more embodiments, the latch assembly 124 may secure the front door 120 in the closed position and may include multiple engagement points to distribute closure forces across the door perimeter. The locking pin 126 may provide additional security by preventing inadvertent opening of the latch assembly 124 during transport or storage. The locking pin 126 may be removable to enable quick access or may include a key-operated mechanism for enhanced security.

In one or more embodiments, interior storage elements may be integrated within the enclosure body 110 to organize and secure various tack items. The saddle rack 130 may be adjustable to accommodate different saddle sizes and styles and may include padding or protective surfaces to prevent damage to expensive equipment. Multiple saddle racks 130 may be positioned at different heights or orientations to maximize storage capacity within the available space.

In one or more embodiments, the bridle hook 132 may provide secure mounting points for bridles, halters, and similar equipment. The hooks 132 may be positioned to prevent tangling of straps and may include protective coatings to prevent corrosion or wear. The shelf 134 may provide flat storage surfaces for smaller items such as grooming supplies, medications, or documentation. The shelf 134 may be removable or adjustable to accommodate varying storage requirements.

In one or more embodiments, the hinge assembly 140 may enable the transformation of the compartment between expanded and collapsed configurations. Multiple hinge assemblies 140 may be positioned at strategic locations to coordinate the folding motion of adjacent panels. The hinge assemblies 140 may include locking mechanisms to secure panels in predetermined positions during deployment or collapse operations. The hinges may be designed to withstand repeated cycling while maintaining smooth operation and structural integrity.

In one or more embodiments, removable fasteners 142 may enable the modular assembly of the compartment from individual components. These fasteners 142 may be designed for tool-free installation and removal to facilitate field assembly or reconfiguration. The fasteners 142 may include threaded elements, quick-release mechanisms, or snap-fit connections depending on the specific application requirements.

In one or more embodiments, the mounting bracket 146 may provide the interface between the tack storage compartment 100 and the trailer structure. Multiple mounting brackets 146 may be distributed to ensure adequate load distribution and secure attachment. The brackets 146 may include quick-release mechanisms to enable rapid installation or removal of the entire compartment assembly. The mounting brackets 146 may be adjustable to accommodate variations in trailer door geometry or mounting point locations.

In one or more embodiments, when attached to the trailer rear door 150, the tack storage compartment 100 may swing outward with the door during opening operations. This configuration may provide unobstructed access to the trailer interior for loading and unloading operations while maintaining the stored tack in an accessible location. The mounting system may be designed to support the weight of the loaded compartment during door operation without compromising the structural integrity of either the compartment or the trailer door 150.

### Methods of Use

In one or more embodiments, the collapsible and removable horse tack compartment described herein may be used in various ways. The following methods describe so me exemplary uses, but are not intended to be limiting.

### Deployment Method

In one or more embodiments, the compartment may be deployed from a fully collapsed position against the trailer door. A user may release a securing mechanism holding the compartment in the collapsed position and unfold the main panel outward from the trailer door. The user may continue the unfolding sequence of the remaining panels, extend the compartment to a fully deployed position, and engage a locking mechanism to secure the compartment in the deployed position.

### Collapsing Method

In one or more embodiments, the compartment may be collapsed from a fully deployed position. A user may release a locking mechanism securing the deployed position and initiate a folding sequence, starting with the outermost panel. The user may fold each panel in a prescribed sequence and complete the folding until the compartment is compact against the trailer door. The user may then engage a securing mechanism to maintain the collapsed position.

### Mounting Method

In one or more embodiments, the compartment may be mounted to a trailer door by aligning mounting interface points with rubber wells on the trailer door. A user may insert the mounting points into corresponding wells and apply pressure to fully seat the mounting connections. The user may verify secure attachment by testing stability and engage any additional securing mechanisms.

### Removal Method

In one or more embodiments, the compartment may be removed from a trailer door by ensuring the compartment is in a collapsed position and disengaging any additional securing mechanisms. A user may apply outward force to release the mounting points from the rubber wells and carefully remove the compartment from the trailer door. The removed compartment may be stored in an appropriate location.

### Installation Method

In one or more embodiments, a user may install the compartment by transporting the collapsed compartment to the trailer door and positioning the compartment to align with the rubber wells. The user may insert the mounting points into the wells with appropriate force and verify secure attachment through physical testing. The user may confirm proper installation before use.

### Storage Access Method

In one or more embodiments, a user may access the storage compartment by approaching the rear of the trailer and releasing a securing mechanism for the collapsed compartment. The user may unfold the compartment to a deployed position, secure it in the deployed position, and open an access point to retrieve or store tack items. The user may close the access point when finished and either leave the compartment deployed or collapse it as needed.

### Horse Loading/Unloading Method with Compartment

When loading or unloading horses with the compartment attached, a user may release a locking mechanism if the compartment is deployed and fold the compartment to a collapsed position against the door. The user may secure the compartment in the collapsed position, open the trailer door with the compartment attached, and proceed with horse loading or unloading. After closing the trailer door, the user may return the compartment to a deployed position if desired.

### Maintenance Method

In one or more embodiments, a user may maintain the compartment by periodically inspecting hinges and folding mechanisms, cleaning mounting points and rubber wells to ensure proper fit, checking for loose fasteners or components, applying appropriate lubricants to moving parts, and testing operation through complete deployment and collapse cycles.

### Additional Embodiments and Variations

In some embodiments, the compartment may be manufactured in sections using 3D printing technology. This modular approach may allow for easy shipping and installation by end users on their existing trailers. The sections may be designed to fit together during assembly while allowing for efficient shipping.

In one or more embodiments, the compartment may be constructed of various materials, including but not limited to aluminum, steel, composite materials, or polymers. The choice of material may depend on factors such as weight, durability, cost, and manufacturing capabilities. In one or more embodiments, the compartment may include various features for organizing and securing tack equipment, such as saddle racks, bridle hooks, shelving, or compartments for smaller items. These features may be customizable or adjustable to accommodate different types and sizes of equipment.

In one or more embodiments, the mounting system may be designed to fit various types and models of horse trailers. This versatility may allow the compartment to be used with a wide range of existing trailers without requiring significant modifications to the trailer itself. In one or more embodiments, the folding mechanism may include various types of hinges, joints, or articulating connections. These may be designed for durability, smooth operation, and resistance to the vibrations and movements associated with trailer transportation. In one or more embodiments, the compartment may include weather sealing elements to protect the contents from dust, moisture, and other environmental factors. These may include gaskets, seals, or overlapping edges that prevent water infiltration.

In one or more embodiments, the locking mechanisms may include various types of latches, clasps, pins, or other securing devices. These may be designed for ease of use, security, and resistance to accidental opening during transit. In one or more embodiments, the compartment may include features for ventilation to prevent moisture buildup and mildew formation. These may include vents, drainage holes, or materials that allow for air circulation while still protecting the contents.

In one or more embodiments, the compartment may be designed with safety features to prevent injury to users or horses. These may include rounded edges, secure latching to prevent accidental opening, and stable mounting to prevent detachment during use. In one or more embodiments, the compartment may be customizable in terms of size, configuration, or features to accommodate different user needs or trailer types. This customization may be achieved through modular components, adjustable elements, or different manufacturing specifications.

In one or more embodiments, the panels of the enclosure body 110 may be manufactured from various materials depending on application requirements and performance specifications. Aluminum panels may provide lightweight construction while maintaining structural integrity under transport loads. The aluminum may have a thickness ranging from approximately 0.050 inches to 0.125 inches, with 0.063 inches representing a balance between weight and durability. Composite materials may offer enhanced strength-to-weight ratios and may include fiberglass reinforced plastics or similar engineered materials. Carbon fiber reinforced panels may provide maximum strength with minimal weight addition, though at increased material cost.

In one or more embodiments, the geometric configuration of the enclosure body 110 may vary to accommodate different trailer door geometries and user preferences. A trapezoidal housing geometry may provide optimized storage volume while maintaining structural stability during folding operations. The trapezoidal shape may taper from a wider base dimension to a narrower top dimension, creating a stable configuration when mounted to the trailer door 150. Alternatively, a rectangular housing geometry may offer simplified manufacturing and assembly while providing uniform storage dimensions throughout the compartment height.

Reinforcement members may be integrated into the panel construction to enhance durability without compromising the collapsible functionality. These reinforcement elements may include internal ribs, edge stiffeners, or frame members that distribute loads across the panel surfaces. The reinforcement members may be formed integrally with the panels during manufacturing or may be attached as separate components during assembly. Strategic placement of reinforcement members may occur at high-stress locations such as hinge mounting points, latch engagement areas, and mounting bracket attachment zones.

In one or more embodiments, the hinge assemblies 140 may employ various mechanical configurations to achieve reliable folding operation while maintaining structural connection between panels. Piano hinges may extend continuously along the full length of panel edges, providing distributed load support and smooth folding motion. The piano hinge may include multiple knuckles with removable or fixed pins to enable assembly and disassembly operations. Segmented modular hinges may comprise discrete hinge elements positioned at predetermined intervals along panel edges. Each segment may operate independently while coordinating with adjacent segments to achieve overall panel folding motion.

Alternative hinge configurations may include living hinges formed integrally with the panel materials, particularly when using flexible composite or polymer materials. Living hinges may eliminate separate hardware components while providing reliable folding operation through material flexure. Interlocking modular hinges may provide rapid assembly capabilities through snap-fit or twist-lock engagement mechanisms that eliminate the need for separate fasteners during field installation.

In one or more embodiments, the latch assemblies 124 may incorporate various closure mechanisms to secure the front door 120 in the closed position while providing reliable access when needed. Rotary latches may include a rotating cam element that engages with a striker plate or catch mechanism. The rotary motion may provide mechanical advantage to achieve secure closure while requiring minimal operating force from the user. The locking pin 126 may insert through the rotary latch mechanism to prevent inadvertent rotation during transport or storage operations.

Quick-release latches may enable rapid access to the compartment contents without requiring tools or complex manipulation. These latches may include spring-loaded mechanisms that maintain closure force until deliberately released by user action. Cam-style latches may provide over-center locking action that maintains secure closure even under vibration or dynamic loading conditions. The cam mechanism may include an ergonomic handle or lever that provides comfortable operation while generating sufficient mechanical advantage for reliable engagement.

Spring-loaded latch mechanisms may automatically engage when the door 120 is closed, providing positive closure feedback to the user. The spring force may be calibrated to maintain secure closure while allowing reasonable opening force requirements. Multiple latch points may be distributed around the door perimeter to provide uniform closure pressure and prevent warping or distortion of the door under load.

In one or more embodiments, the mounting bracket system 146 may provide secure attachment to the trailer door 150 while enabling rapid installation and removal operations. Quick-release mounting brackets may incorporate cam-lever mechanisms, quarter-turn fasteners, or spring-loaded pins that secure the compartment without requiring tools. The mounting interface may include alignment features that guide proper positioning during installation and prevent incorrect assembly orientations.

In one or more embodiments, the mounting brackets 146 may distribute attachment loads across multiple points on the trailer door 150 to prevent localized stress concentrations. Load distribution plates may spread mounting forces over larger areas of the door structure, reducing the risk of deformation or failure at attachment points. The brackets may include vibration isolation elements such as rubber bushings or dampening materials to reduce noise and wear during transport operations.

Adjustable mounting brackets may accommodate variations in trailer door geometry, thickness, or existing hardware configurations. The adjustment capability may include sliding, telescoping, or multi-position mounting points that enable compatibility with various trailer manufacturers and models. Universal mounting interfaces may provide standardized attachment methods that work across multiple trailer types without requiring custom modifications.

In one or more embodiments, the quick-release capability of the mounting brackets 146 may enable complete removal of the compartment assembly for maximum trailer clearance during alternative hauling operations. The release mechanism may include safety features that prevent accidental detachment during normal transport operations while allowing deliberate removal when desired. Visual indicators may provide confirmation of proper engagement to ensure secure attachment before transport.

Interior storage elements may be configured to accommodate the specific requirements of horse tack organization and protection. The saddle rack 130 may include adjustable positioning to accommodate various saddle sizes, styles, and configurations. Western saddles, English saddles, and specialty saddles may require different support geometries and spacing requirements. The rack may include protective padding or covering materials to prevent scratching or damage to expensive leather equipment.

Multiple saddle racks 130 may be positioned at different heights or orientations within the compartment to maximize storage capacity while maintaining accessibility. The racks may be removable to allow reconfiguration of the interior space for different equipment combinations. Quick-release mounting of the saddle racks 130 may enable field reconfiguration without tools or complex procedures.

In one or more embodiments, the bridle hooks 132 may be strategically positioned to prevent tangling of straps and reins while providing secure support for various bridle styles. The hooks may include protective coatings or materials to prevent corrosion from moisture or leather treatment chemicals. Multiple hook configurations may accommodate different bridle types, halters, lead ropes, and similar equipment. The hooks 132 may be adjustable in position or orientation to optimize organization for specific user requirements.

Shelf systems 134 may provide flat storage surfaces for smaller items such as grooming supplies, medications, tools, or documentation. The shelves may be removable or adjustable in height to accommodate varying storage requirements. Perforated or ventilated shelf designs may promote air circulation to prevent moisture accumulation and mildew formation. Edge barriers or lips on the shelves may prevent items from sliding during transport operations.

In one or more embodiments, the modular construction approach may enable the compartment to be shipped as a kit containing all necessary components for field assembly. The kit may include pre-fabricated panels, hinge hardware, latch assemblies, mounting brackets, interior storage elements, and all required fasteners. Assembly instructions may provide step-by-step guidance for proper installation and configuration. The modular approach may reduce shipping costs by enabling compact packaging while providing end users with customization flexibility during assembly.

Tool-free assembly may be achieved through the use of quarter-turn fasteners, snap-fit connections, or other quick-connect hardware that eliminates the need for specialized tools during installation. Color-coding or visual indicators may guide proper component orientation and assembly sequence. Pre-drilled holes and alignment features may ensure accurate positioning of components during assembly operations.

In one or more embodiments, the kit packaging may include protective materials to prevent damage during shipping while maintaining compact dimensions for cost-effective distribution. Individual components may be nested or stacked to minimize package volume while providing adequate protection for finished surfaces and precision-machined features.

Weather sealing elements may be integrated into the compartment design to protect stored equipment from environmental conditions during transport and storage. Gasket materials may be positioned along door edges and panel joints to prevent water infiltration. Overlapping panel edges may provide secondary weather protection through geometric sealing without requiring separate sealing materials.

Drainage features may be incorporated into the bottom panel 114 to allow removal of any moisture that may enter the compartment. Drain holes or channels may be positioned to direct water away from stored equipment while preventing accumulation that could lead to corrosion or mildew formation. The drainage system may include removable plugs or covers that enable cleaning and maintenance access.

Ventilation elements may promote air circulation within the compartment to prevent moisture buildup and maintain equipment condition. Ventilation openings may be positioned to provide airflow while preventing direct water entry. Filtered vents may exclude dust and debris while allowing air exchange. The ventilation system may be designed to function effectively in both deployed and collapsed configurations.

In one or more embodiments, the compartment may include features to accommodate various trailer door opening mechanisms and geometries. Clearance provisions may ensure that the compartment does not interfere with door hardware, latches, or structural elements. The mounting system may be positioned to avoid conflict with existing trailer features while providing secure attachment points.

When configured to swing outward with the trailer door 150, the compartment may provide unobstructed access to the trailer interior for horse loading and unloading operations. The swing-out operation may occur automatically as the door opens, requiring no additional user action. The compartment weight and mounting configuration may be balanced to avoid affecting normal door operation or creating undue stress on door hinges.

Safety features may be incorporated to prevent injury to users or animals during compartment operation. Rounded edges and corners may eliminate sharp projections that could cause cuts or abrasions. Smooth operation of hinges and latches may prevent pinching or crushing hazards. Positive locking mechanisms may prevent unexpected collapse or movement during use.

In one or more embodiments, the compartment design may accommodate multiple intermediate positions between fully collapsed and fully extended configurations. Intermediate locking positions may provide partial deployment options for specific storage requirements or space constraints. The locking mechanisms may include detents, pins, or other positive engagement features that secure the compartment in predetermined positions.

Customization options may enable adaptation of the basic compartment design to specific user requirements or trailer configurations. Modular interior components may allow users to configure storage elements according to their equipment inventory and preferences. Optional accessories may include specialized racks for different equipment types, additional shelving systems, or security enhancements.

In one or more embodiments, the manufacturing approach may utilize various production methods depending on volume requirements and cost considerations. Traditional fabrication methods may include cutting, forming, and welding of metal components. Advanced manufacturing techniques may include 3D printing of complex geometries, injection molding of polymer components, or composite layup processes for lightweight panels.

Quality control measures may ensure consistent performance and reliability across production quantities. Testing procedures may verify folding operation, load capacity, weather resistance, and durability under simulated transport conditions. Standardized testing protocols may establish performance criteria for various operating conditions and use cases.

In one or more embodiments, the collapsible and removable horse tack compartment described herein provides an improved storage solution for horse tack and equipment that overcomes limitations of conventional rear tack compartments in horse trailers. By being affixed to the rear door of the trailer, the compartment swings out with the door during opening, providing unobstructed access for loading and unloading horses without first having to empty the compartment of gear. The collapsible and removable design allows for versatility in trailer use, enabling the compartment to be folded flat when not in use or completely removed when additional hauling space is needed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A collapsible and removable tack storage compartment for a horse trailer, comprising: a housing defined by panels comprising a top, bottom, sides, rear wall, and front door; hinge assemblies interconnecting the panels; latch assemblies securing the door; and mounting brackets for attachment to a trailer, wherein the compartment is foldable into a collapsed configuration and removable from the trailer.

2. The tack storage compartment of claim 1, wherein the housing has a trapezoidal geometry.

3. The tack storage compartment of claim 1, wherein the housing has a rectangular geometry.

4. The tack storage compartment of claim 1, wherein the panels are formed of aluminum.

5. The tack storage compartment of claim 1, wherein the panels are formed of composite material.

6. The tack storage compartment of claim 1, wherein the panels are formed of carbon fiber reinforced material.

7. The tack storage compartment of claim 1, wherein the hinge assemblies comprise a piano hinge.

8. The tack storage compartment of claim 1, wherein the hinge assemblies comprise a segmented modular hinge.

9. The tack storage compartment of claim 1, wherein the latch assemblies comprise a rotary latch with a locking pin.

10. The tack storage compartment of claim 1, wherein the latch assemblies comprise a quick-release latch.

11. The tack storage compartment of claim 1, further comprising at least one adjustable saddle rack.

12. The tack storage compartment of claim 1, further comprising at least one removable saddle rack.

13. The tack storage compartment of claim 1, further comprising at least one bridle hook.

14. The tack storage compartment of claim 1, further comprising at least one shelf.

15. The tack storage compartment of claim 1, wherein the mounting brackets comprise a quick-release bracket permitting tool-free removal.

16. The tack storage compartment of claim 1, wherein reinforcement members are integrated into the panels for durability.

17. The tack storage compartment of claim 1, configured to swing outward with a trailer door.

18. The tack storage compartment of claim 1, wherein the panels are configured to be folded and locked in multiple intermediate positions.

19. A kit for forming a collapsible and removable tack storage compartment, comprising modular panels, hinges, latch assemblies, and mounting brackets, wherein the kit is configured for end-user assembly into the tack storage compartment of claim 1.

20. The kit of claim 19, wherein the kit further comprises quick-release brackets and instructions for tool-free assembly.
